(19) United States
(12) Patent Application Publication
(10) Pub. No.: US 2005/0119020 A1
(43) Pub. Date: Jun. 2, 2005

(54) Automatically information-collecting method and information-collecting system

(75) Inventors: Ray-Guang Cheng, Keelung (TW); Jian-Zhou Hou, Yungkong City (TW)

Correspondence Address: TROXELL LAW OFFICE PLLC, SUITE 1404, 5205 LEESBURG PIKE, FALLS CHURCH, VA, 22041, US

(73) Assignee: BENQ Corporation

(21) Appl. No.: 11/000,027

(22) Filed: Dec. 1, 2004

(30) Foreign Application Priority Data
Dec. 2, 2003 (TW) 92133776

(51) Int. Cl. B65G 53/00

(52) U.S. Cl. 455/466

(57) ABSTRACT

An automatic information-collecting method and information-collecting system, which is used for the information collection of the mobile unit in a mobile network; the information-collecting system includes: a mobile unit and a information-collecting device, wherein the mobile unit has memory unit, detecting unit, and control unit, and the control unit may switch the mobile unit from a first mode to a second mode; the automatic information-collecting method includes the following steps: a). when the detecting unit detects a triggering condition, a corresponding data is stored into the memory unit; b). when the control unit detects a reporting time, the mobile unit is switched to the second mode; c). checking whether there is data in the memory unit and, if there is no data, then the mobile unit is set to the first mode; d). if data exists, then a short message is used to transfer the data to the information-collecting device, and the mobile unit is then switched to the first mode.

### FIELD OF THE INVENTION

This invention relates to an automatically information-collecting method and information-collecting system, and in particular, to a method and system that use short message of a mobile unit to collect information.

### BACKGROUND OF THE INVENTION

Following the liberating trend of universal communication, the wireless communication industry booms in recent year. The system service of the communication industry becomes very diversified, and the generation of new mobile products is so fast that how to test the mobile unit efficiently becomes an important issue.

When a mobile unit manufacture is developing a mobile unit, a series of tests to verify the stability of the mobile unit is essential. However, during the final period of the development, when most major issues have been solved, the remaining ones are related to the problems of cellular system operator or the stability of the mobile unit. Such problems may be happened randomly, so research engineers have to make field tests to obtain sufficient testing sample as debugging accordance. However, such debugging manner needs experienced engineers to operate advanced instruments. It is very laborious and not easy to collect useful samples for debugging the problem of the mobile unit or the cellular system. The most problem of the cellular system are such as the communication dead corners, wireless network plan analysis, or the monitoring system capacity. There are also further applications, for example, the monitoring of traffic flow. The present invention can solve the problems mentioned above and also provide application in a cost-saving manner.

### SUMMARY OF THE INVENTION

The main objective of the invention is to provide an automatic information-collecting method and system thereof. The mobile unit in a cellular system automatically collects information and sending the information by short message(s). The information may be erroneous information when the mobile unit makes filed testing.

The information-collecting system includes: a mobile unit and an information-collecting device. The mobile unit and the information-collecting device may be using in a cellular system. The mobile unit is used for detecting purpose and temporarily stores the report data. The mobile unit is selectively switched between a first mode and a second mode. Normally, the mobile unit stays in the first mode for normal operations. When the mobile unit detects a triggering condition, the mobile unit switches to the second mode and, through the mobile cellular system, the report data is transmitted to the information-collecting device by a short message(s). As the report data has delivered, the mobile unit releases the triggering condition and switches back to the first mode. The information-collecting device receives the short message(s) then analysis them for performing a calculation in a predetermined manner to obtain relative system parameters of the mobile cellular system.

The automatic information-collecting method, which based on mobile unit's short messages to interchange information, can be applied in an information-collecting system, the information-collecting system including, a information-collecting device and a mobile unit, the mobile unit selectively switching between a first mode and a second modes a detecting unit, a control unit and a memory unit, the automatic information-collecting method includes the following steps: a). when the detecting unit detects a triggering condition, a corresponding data is stored into the memory unit; b). when the control unit detects a reporting condition, the mobile unit is switched to the second mode; c). checking whether there is data in the memory unit and, if the condition is “No”, then the mobile unit is set back to the first mode; d). if data exists, then the data is transmitted to the information-collecting device by a short message(s), and then the mobile unit is switched back to the first mode again; e). the information-collecting unit analyzes the data for the purpose of inquiry.

To make your esteemed members of reviewing committee further recognize and understand the characteristic, objective, and function of the invention, a detailed description cooperating with corresponding drawing is presented thereinafter.

### BRIEF DESCRIPTION OF THE DRAWINGS

FIG. 1 is a preferred embodiment of the information-collecting system according to the present invention.

FIG. 2 is a preferred embodiment of a mobile unit according to the present invention.

FIG. 3 is a preferred embodiment of a data-receiving unit according to the present invention.

FIG. 4 is a flowchart of the automatic information-collecting method according to the present invention.

### DETAILED DESCRIPTION OF THE INVENTION

For your esteemed members of reviewing committee to further understand and recognize the fulfilled functions and structural characteristics of the invention, several preferable embodiments cooperating with detailed description are presented as the follows.

The main purpose of the invention is for a mobile unit collecting information in the field and reporting the information by a short message(s). When the mobile unit is in a reporting status, the mobile unit has not to be in a communication state.

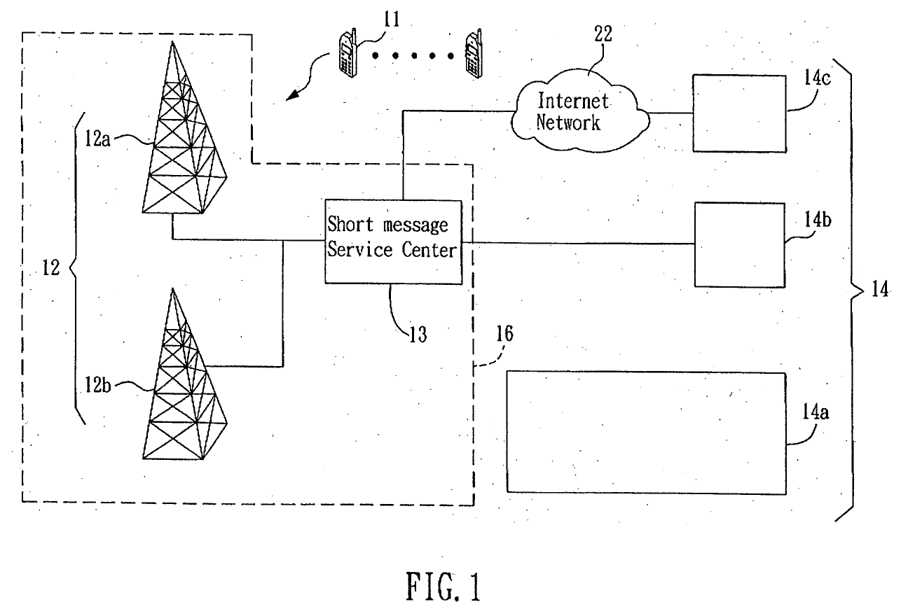

Please refer to FIG. 1, which shows a preferred embodiment of a system according to the present invention. The system includes: plural mobile units 11, a mobile cellular system 16, and an information-collecting device 14. The mobile cellular system 16 includes: plural bases 12a, 12b, a short message service center 13. General speaking, bases 12a and 12b are popularly constructed as a cellular mobile phone system. The information-collecting device 14 may have an arrangement of many kinds. For example, the information-collecting device may be arranged in a mobile cellular system 16 and acted as a special mobile unit 14a, or the information-collecting device 14b may be arranged to connect to the short message service center 13 directly, or the information-collecting device 14c may be connected to the short message service center 13 through the Internet network 22. However, the mobile unit 11 will be preset with a number related to the information-collecting device 13, for example, a telephone number or a internet position, the number is acting as an accordance of information transmission for accurately transferring the information to the information-collecting device 14a, 14b or 14c. The short message transmitted by the short message service center 13 may be a Short Message Service (SMS), an Electronic Message Service (EMS), or a Multimedia Messaging Service (MMS), and the short message is further connected to the internet network 22. The mobile unit 11 has two communication modes: a first mode, which is a normal mobile phone mode, and a second mode, which is a reporting mode. The normal mobile phone mode is a state when the mobile unit maintains normal operation, for example mobile phone connections. The reporting mode will function with a preset triggering condition and a reporting condition to report a short message(s) to the information-collecting device 14. The information-collecting device 14 records and arranges the collected information.

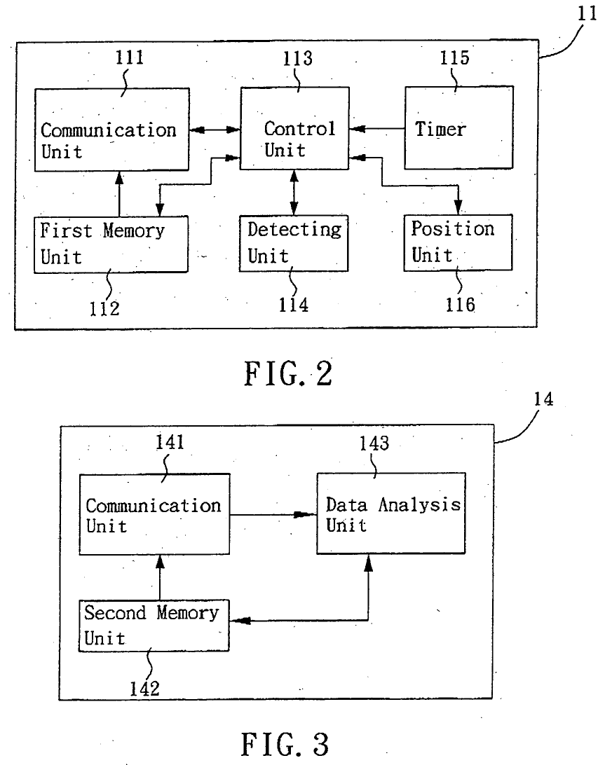

As shown in FIG. 2, the mobile unit 11 includes: a communication unit 111, a first memory unit 112, a control unit 113, a detecting unit 114, and a timer 115. If it is needed to report the position of the mobile unit 11, a position unit 116 may further be included in the mobile unit 11 to obtain the position information. The detecting unit 114 is used for detecting the data desired to be reported, for example, the debugging message of the mobile unit 11 itself, the number of base stations in the neighborhood of the mobile unit 11, or the information of the base station currently using. The control unit 113 stores this information desired to be reported in the first memory unit 112. The mobile unit 11 is switched from the first mode to the second mode at an appropriate condition. Under the second mode, the data stored in the first memory unit 112 is transmitted. After the transmission, the mobile unit 11 is switched back to the first mode again. The appropriate switching condition is, for example, a periodic time calculated by the timer, or when the data stored in the first memory unit 112 exceeds a specific size. In addition, if the transmission of the short message(s) is failed, then the short message(s) is stored in the first memory unit 112 and waits for the next transmission.

Next, as shown in FIG. 3, the information-collecting unit 14 includes: a communication unit 141, a second memory unit 142, and a data-analyzing unit 143. The communication unit 141 may be a wireless interface used in the mobile cellular system 16 to receive the short message(s), or a network card in an Internet work used for a wired transmission. All kinds of information-collecting unit are to receive the short message(s) transmitted from the mobile unit 11. When the communication unit 141 receives the short message, the information in the short message is first stored in the second memory unit 142. The data-analyzing unit 143 may then perform an analysis to the data stored in the second memory unit 142 to obtain a result that needs to be analyzed for future inquiry.

An embodiment is presented now to describe how an information-collecting system collects the information of the switching position and the switching time when the mobile unit 11 switches the base 12. The triggering condition happens when the mobile unit 11 switches base 12, for example, the mobile unit 11 being switched from the base 12a to the base 12b. The position unit 116 records the coordinate and sends it to the control unit 113 when a switching occurred. The detecting unit 114 detects the base's identity when the switching occurred and sends it to the control unit 113. In addition, the timer 115 sends the switching time to the control unit 113. The control unit 113 records the coordinate, the time, and the base's identity into the first memory unit 112 during each time when the mobile unit 11 is switching the base 12. In this embodiment, the reporting time is preset as one hour, so when the transferring time calculated by the timer is reached, the control unit 113 will switch the mobile unit 11 into a second mode, then the switching information is transmitted out as a short message(s) by the preset phone number or IP address of the information-collecting device 14. The base 12 sends the short message(s) desired to be sent to the short message service center 13 for an arrangement then, according to the phone number of the information-collecting device 14, the short message service center 13 sends the arranged information to the information-collecting device 14 through the base 13. With such mechanism, the mobile unit 11 uses a short message(s) to transfer the data desired to be collected to the information-collecting device 14.

After receiving the short message transmitted from the mobile unit 11, the information-collecting device 14 will store the short-message's information in the second memory unit 142 and categorize the information according to the phone number associated to the mobile unit 11. In this embodiment, the information stored in the second memory 142 is the information about the mobile unit 11 switching the base, so a data-analyzing unit 143 may be further used to read the relative information of the second memory 142 to perform a predetermined operation. For example, when the switching position and the switching time of the base 12 are known, it is possible to allocate the actual switching boundary between the bases 12 or to determine whether the switching boundary is changed according to time, so such kind of information may be used for the adjustment to the system.

In other preferred embodiments, the triggering condition may be one of as follows: the hardware error and the software error occurred in the mobile unit 11, the down times of the mobile unit 11, and other system error information desired to be collected by the mobile unit manufacturer. The reporting time may be one of as: an appropriate time interval past by, memory unit of the mobile unit is full, and the mobile unit 11 is rebooted. The information corresponding to the triggering condition may be: the hardware identifying code of the mobile unit 11, the hardware version of the mobile unit 11, the information describing the triggering condition, the codes corresponding to the triggering condition, and the location of the mobile unit 11. In this preferred embodiment, the triggering condition, the reporting time, and the information corresponding to the triggering condition are preset already in the mobile unit 11 before the test, so, when the triggering condition and the reporting time are met, the information corresponding to the triggering condition is therefore transmitted to the information-collecting device 14, however, these parameters may also be set with the short message through the base 12.

The present invention may also be adapted for detecting the moving speed of the mobile unit 11, that is, the reporting short message of the mobile unit 11 may include the position of the mobile unit 11 and the time, with the time difference and the position difference, the moving speed of the mobile unit 11 can be obtained, and this information can be used as a prediction for the traffic situation in the area around the mobile unit 11.

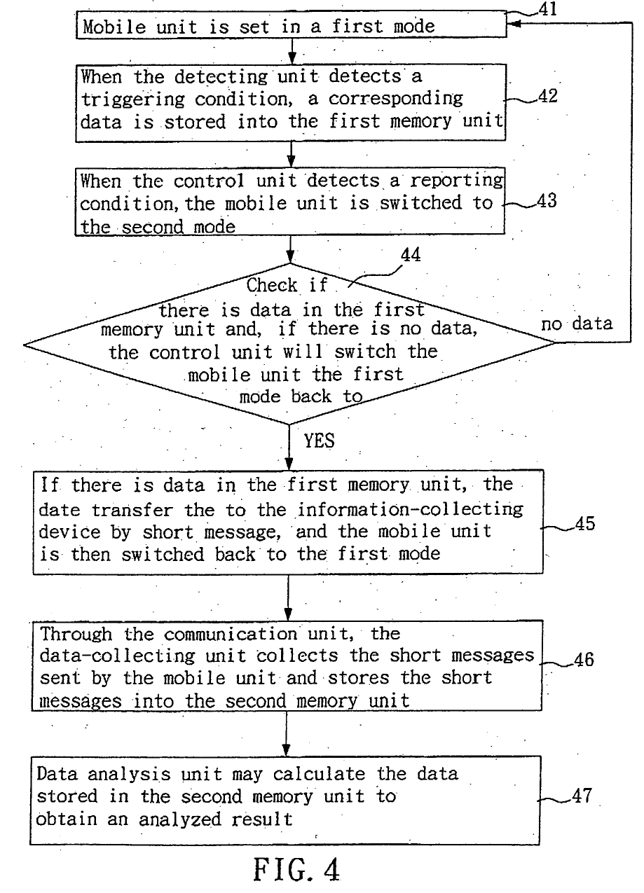

Please refer to FIG. 4, which shows the flowchart of a preferred embodiment of the automatic information-collecting method according to the present invention. This method may be adapted for the information-collecting system shown in FIG. 1. The method includes the following steps:

Step 41: Mobile unit 11 is set in a first mode that is a mobile unit mode, in which the mobile unit 11 is under a general communication state;

Step 42: When the detecting unit 114 detects the triggering condition, a corresponding data is stored into the first memory unit 112, wherein the triggering condition may be: the hardware error or the software error occurred in the mobile unit 11, the number of the system errors of the mobile unit 11, and the other error information desired to be collected by the mobile unit manufacturer, and the information corresponding to the triggering condition can be one of: the hardware identifying code of mobile unit 11, the hardware, version of the mobile unit 11, the information describing the triggering condition, the code corresponding to the triggering condition, and the position of the mobile unit 11;

Step 43: When the control unit 113 detects a reporting time, the mobile unit 11 is switched to the second mode, which is a reporting mode that may automatically report the data in the first memory unit 112, and the reporting time may be preset as on of the following situations: an appropriate time period passed, the first memory of the mobile unit 11 is full, and the mobile unit 11 is rebooted;

Step 44: Checking whether there is data in the first memory unit 112 and, if there is no data, then the control unit 113 will switch the mobile unit 11 into the first mode;

Step 45: If data exists in the first memory unit 112, then a short message is used to transmit the data to the information-collecting device 14, and the mobile unit 11 is then switched back to the first mode;

Step 46: With the communication unit 141, the data-collecting unit 14 collects the short messaged sent out by the mobile unit 11, and the short message is stored in the second memory unit 142, wherein the short message may be one of the Short Message Service (SMS), Electronic Message Service (EMS), or Multimedia Messaging Service (MMS) and, through the short message service center, the short massage may further be connected to the Internet network 22 and be transmitted to the data-collecting unit 14;

Step 47: The data-analyzing unit 143 performs an operation to the data in the second memory unit 142 to obtain the results desired to be analyzed.

However, the above description is only the preferable embodiment according to the present invention, and it should not be regarded as a limitation to the executing range of the invention. Any equivalent variation and modification made according to the claims claimed by the invention should be included within the ranges covered by the invention patent. Please your esteemed members of reviewing committee examine this application as carefully and favorably as possible and grant it as a formal patent the sooner the better.

1. An information-collecting system in a mobile cellular system, the information-collecting system comprising:
a mobile unit comprising a first memory unit and a detecting unit, the detecting unit for detecting a detecting data to store in the first memory unit, when the mobile unit switching to a reporting mode, the detecting data transmitted by a short message; and
a information-collecting device comprising a communication unit and a second memory unit, the communication unit receiving the short message and the short message storing into the second memory unit.

2. The information-collecting system according to claim 1, the mobile unit further comprising a control unit for switching the mobile unit to a normal mode after the short message transmitted, the mobile in the normal mode for normal operations.

3. The information-collecting system according to claim 1, the mobile unit further comprising a positioning unit for providing a position information of the mobile unit.

4. The information-collecting system according to claim 3, the mobile unit further comprising a timer for generating a time information, the detecting data including the position information and time and a time information.

5. The information-collecting system according to claim 4, the information-collecting device further comprising a data-analyzing unit for reading the time information and the position information in the short message stored in the second memory unit to calculate a moving speed of the mobile unit.

6. The information-collecting system according to claim 1, the information-collecting device further comprising a data-analyzing unit for reading the short message stored in the second memory unit and performing an analysis to the detecting data.

7. The information-collecting system according to claim 1, wherein the mobile cellular system comprises a plurality of bases for communicating to the mobile unit, when the mobile unit switching bases, the mobile recording a switching time and the associated bases as the detecting data.

8. The information-collecting system according to claim 1, further comprising:
a short message service center for transmitting the short message in a wireless manner or in a wired network.

9. An automatic information-collecting method for an information-collecting system, the system comprising an information-collecting device and a mobile unit, the mobile unit for selectively switching to a first mode and a second mode, the mobile unit further comprising a detecting unit, a control unit, and a memory unit, the method comprising:
storing a detecting data into the memory unit when the detecting unit detecting a triggering condition;
switching the mobile unit to the second mode when the control unit detecting a reporting condition;
checking whether the detecting data in the memory unit, if no data in the memory unit, switching the mobile unit to the first mode; and
transmitting a short message including the detecting data to the information-collecting device if the detecting data storing in the memory data;
switching the mobile unit to the first mode.

10. The method according to claim 9, the method further comprising: the information-collecting unit analyzing and arranging the detecting data.

11. The method according to claim 9, the triggering condition being an predetermined condition storing in the mobile unit in advance.

12. The method according to claim 9, if transmitting of the short message failed, storing the detecting data to the memory unit.

13. The method according to claim 9, wherein the information includes the position information of the mobile unit.

14. A mobile unit for using in a mobile cellular system to collect a detecting data and transmitting it to an information-collecting unit, the mobile unit comprising:
a detecting unit for collecting a detecting data;
a first memory unit;
a communication unit; and
a control unit for storing the detecting data into the first memory unit, the detecting data being transmitted from the first memory unit to the communication unit when the control unit detecting a reporting condition, the communication unit transmitting a short message to the information-collecting unit through the mobile cellular system, the short message comprising the detecting data.

15. The mobile unit according to claim 14, the mobile unit further comprising:
a timer for connecting to the control unit, when the timer counting to a default time the control unit detecting the reporting condition.

16. The mobile unit according to claim 14, wherein the detecting data comprising a irregular operation record of the mobile unit.

17. The mobile unit according to claim 14, the mobile unit further comprising:
a timer; and
a position unit;
wherein the timer and the position provide a time information and a position information to the control unit, the control unit storing the time information and the position information in the first memory unit as the detecting data.

18. The mobile unit according to claim 14, wherein the reporting condition is when the detecting data in the first memory unit is full.
